(19) United States
(12) Patent Application Publication
(10) Pub. No.: US 2016/0006048 A1
(43) Pub. Date: Jan. 7, 2016

(54) Unknown

(71) Applicant: Robert Bosch GmbH, Stuttgart (DE)

(72) Inventors: Norbert Domaschke, Stuttgart (DE); Peter Schroepfer, Leinfelden-Echterdingen (DE); Friedrich Kneule, Rutesheim (DE); Armin Schuelke, Rutesheim-Heuweg (DE); Maxime Carre, Stuttgart (DE)

(21) Appl. No.: 14/792,769

(22) Filed: Jul. 7, 2015

(30) Foreign Application Priority Data
Jul. 7, 2014 (DE) 102014213102.2

(51) Int. Cl. H01M 8/04; H01M 8/06

(52) U.S. Cl. CPC H01M 8/04074; H01M 8/0618

(57) ABSTRACT

A fuel cell device having a fuel cell unit (12) which has at least one anode (14) and at least one cathode (16), having at least one anode gas processor (18) which has at least one first heat exchanger (20), and having at least one cathode gas processor (22) which has at least one second heat exchanger (24). The at least one first heat exchanger (20) and the at least one second heat exchanger (24) each take a helical form.

### BACKGROUND OF THE INVENTION

The invention relates to a fuel cell device.

A fuel cell device which has a fuel cell unit, an anode gas processor having a first heat exchanger, and a cathode gas processor having a second heat exchanger is already known.

### SUMMARY OF THE INVENTION

The invention takes as its starting point a fuel cell device having a fuel cell unit which has at least one anode and at least one cathode, having at least one anode gas processor which has at least one first heat exchanger, and having at least one cathode gas processor which has at least one second heat exchanger.

It is proposed that the at least one second heat exchanger be at least partly guided around a receiving chamber within which the at least one first heat exchanger is arranged.

The term “fuel cell device” should be understood in this context in particular to mean a device for obtaining, in stationary and/or mobile manner, in particular electrical and/or thermal energy using at least one fuel cell unit. The term “fuel cell unit” should be understood in this context in particular to mean a unit having at least one fuel cell which is provided for the purpose of converting at least chemical energy from at least one in particular continuously supplied fuel gas, in particular hydrogen and/or carbon monoxide, and at least one oxidizing agent, in particular oxygen, in particular into electrical energy. The at least one fuel cell may in particular take the form of a solid oxide fuel cell (SOFC). Preferably, the at least one fuel cell unit comprises a plurality of fuel cells which are arranged in particular in a fuel cell stack which is in particular tubular and/or planar. The term “provided” should be understood in particular to mean specially programmed, laid out and/or equipped. The expression that an object is provided for the purpose of a particular function should in particular be understood to mean that the object fulfills and/or performs this particular function in at least one condition of use and/or operating condition.

The term “gas processor” should be understood in this context in particular to mean a unit which is provided for the purpose of preparing an in particular gaseous fluid before it is fed to an anode and/or a cathode of the fuel cell unit for use within a reaction that is carried out in the fuel cell unit. In particular, the at least one anode gas processor is provided for the purpose of heating in particular a natural gas and/or a fuel gas and/or a gas mixture containing a fuel gas to a reaction temperature, and/or for the purpose of converting the natural gas to a fuel gas and/or a fuel gas mixture. The term “natural gas” should be understood in this context in particular to mean a gas and/or a gas mixture, in particular a natural gas mixture which comprises at least one alkane, in particular methane, ethane, propane and/or butane. Moreover, the natural gas may have further constituents such as in particular carbon dioxide and/or nitrogen and/or oxygen and/or sulfur compounds. The at least one cathode gas processor is in particular provided for the purpose of heating in particular surrounding air to a reaction temperature. The term “heat exchanger” should be understood in this context in particular to mean a unit which is provided for the purpose of transferring heat toward a temperature difference between at least two in particular fluid substance streams, preferably in a cross-flow operation. The at least one first heat exchanger is in particular provided for the purpose of transferring heat from at least one fluid substance stream, in particular an exhaust gas, preferably an anode exhaust gas of the fuel cell unit, in particular to the natural gas and/or a fuel gas and/or a gas mixture containing a fuel gas that is supplied in at least one operating condition of an anode of the fuel cell unit. The at least one second heat exchanger is in particular provided for the purpose of transferring heat from at least one fluid substance stream, in particular an exhaust gas and/or an exhaust gas mixture of the fuel cell unit, to surrounding air that is supplied in at least one operating condition of a cathode of the fuel cell unit.

The expression that the at least one second heat exchanger is at least partly “guided around” a receiving chamber should be understood in particular to mean that the receiving chamber is surrounded in the peripheral direction, in particular at least in certain regions, in a direction along the longitudinal extent of the receiving chamber, at least partly and preferably at least substantially by an inner surface of the at least one second heat exchanger. The term “peripheral direction” of an object should be understood in particular to mean an azimuthal direction arranged perpendicular to a direction of longitudinal extent of the object. The term “direction of longitudinal extent” of an object should be understood in particular to mean a direction parallel to a longest edge of a smallest geometric cuboid that just passes around the object. The expression that the receiving chamber is “at least substantially surrounded” by an inner surface of the at least one second heat exchanger should be understood in particular to mean that the inner surface of the at least one second heat exchanger surrounds the receiving chamber in a mounted condition, and a total surface area of all the recesses in the inner surface of the heat exchanger is in particular at most 40%, in particular no more than 30%, preferably at most 20% and particularly advantageously no more than 10% of a total surface area of the inner surface of the heat exchanger. The at least one first heat exchanger is in particular partly, advantageously at least by a majority and preferably entirely arranged within the receiving chamber. In this context, the expression “at least by a majority” should be understood to mean at least by 60%, advantageously at least by 70%, preferably at least by 80% and particularly preferably at least by 90%.

As a result of the embodiment according to the invention, a generic fuel cell device having advantageous operating properties may be created. In particular, it is possible for both a fuel gas that is supplied to the fuel cell unit on the anode side in at least one operating condition, and also surrounding air which is supplied to the fuel cell unit on the cathode side in at least one operating condition advantageously to be heated to a reaction temperature as a result of which the efficiency of the fuel cell unit may advantageously be increased. Moreover, the arrangement of the at least one first heat exchanger within a receiving chamber around which the at least one second heat exchanger is guided makes it possible to reduce the space requirement in advantageous manner.

It is moreover proposed that the at least one first heat exchanger have at least one first hollow-profile coil and/or the at least one second heat exchanger have at least one second hollow-profile coil. The term “hollow-profile coil” should be understood in this context in particular to mean a preferably helical hollow conductor which is wound around an outer face of a notional cylinder, in particular at a constant pitch. The at least one first hollow-profile coil is in particular provided for the purpose of supplying a natural gas and/or a fuel gas and/or a gas mixture containing a fuel gas to the anode of the fuel cell unit. The at least one second hollow-profile coil is in particular provided for the purpose of supplying surrounding air to the cathode of the fuel cell unit. The at least one first heat exchanger preferably has at least one first annular gap, within which the at least one first hollow-profile coil is arranged. The at least one second heat exchanger preferably has at least one second annular gap, within which the at least one second hollow-profile coil is arranged. As a result of this, an advantageously simple and/or low-cost construction of the at least one first heat exchanger and/or the at least one second heat exchanger can be achieved. Moreover, by using hollow-profile coils an advantageous heat transfer can be obtained.

In a preferred embodiment of the invention, it is proposed that the fuel cell unit be arranged at least partly, advantageously at least by a majority and preferably entirely within the receiving chamber. As a result of this, a natural gas that is supplied to the fuel cell unit may advantageously simply be converted into a fuel gas and/or a gas mixture that contains a fuel gas. Preferably, an anode exhaust gas of the fuel cell unit is diverted into the at least one first annular gap within which the at least one first hollow-profile coil is arranged. As a result of arranging the fuel cell unit within the receiving chamber, advantageously the space requirement may be further reduced. Moreover, the fuel cell unit may advantageously simply, in particular by fluid engineering means, be connected to the at least one first heat exchanger and/or the at least one second heat exchanger.

Furthermore, it is proposed that the at least one anode gas processor have a reformer unit that is at least partly, advantageously at least by a majority and preferably entirely arranged within the receiving chamber. The term “reformer unit” should be understood in this context in particular to mean a chemical engineering unit for at least preparing the natural gas, in particular by steam reforming and/or by partial oxidation and/or by autothermal reforming, in particular for obtaining at least one fuel gas and/or a gas mixture that contains a fuel gas. As a result of this, a natural gas that is supplied to the fuel cell unit may advantageously simply be converted into a fuel gas and/or a gas mixture that contains a fuel gas. In particular, by arranging a reformer unit within the receiving chamber, it is possible to dispense with an additional external reformer unit, as a result of which advantageously the space requirement may be further reduced.

Moreover, it is proposed that the reformer unit be placed downstream, from the point of view of fluid engineering, of the at least one first heat exchanger. As a result of this, a fluid that is supplied to the reformer unit, in particular a natural gas, may advantageously simply be heated to a reaction temperature.

If the at least one first heat exchanger has at least two partial regions and the reformer unit is placed, from the point of view of fluid engineering, between the at least two partial regions, an advantageously exact heating of the natural gas and the reformate to a respective required reaction temperature can be achieved. In particular, it is possible for a loss in temperature that is caused by the reformer unit to be advantageously compensated. A first partial region of the at least one first heat exchanger, which is placed upstream of the reformer unit from the point of view of fluid engineering, is in particular provided for the purpose of heating a natural gas that is fed to the reformer unit at least substantially to a reaction temperature before it enters the reformer unit. A second partial region of the at least one heat exchanger, which is placed downstream of the reformer unit from the point of view of fluid engineering, is in particular provided for the purpose of heating a reformate that is derived from the reformer unit at least substantially to a reaction temperature before it enters the fuel cell unit. The term “reformate” should be understood in this context in particular to mean a gas mixture that contains a fuel gas and is obtained from the natural gas by means of reforming within the reformer unit.

Furthermore, it is proposed that the at least one cathode gas processor have an afterburning unit which is provided for the purpose of at least largely afterburning at least one combustible constituent of an exhaust gas. Preferably, the afterburning unit is provided for the purpose of at least largely oxidizing fuel gas that is in particular contained within an anode exhaust gas. Oxygen that is required for oxidation of the fuel gas is suppliable to the afterburning unit in particular is the form of a cathode exhaust gas. In particular in a start-up operating condition of the fuel cell device, the afterburning unit may preferably be operated using natural gas. In particular, the afterburning unit may comprise a catalytic afterburner and/or a diffusion burner and/or a recuperative burner and/or a partially or fully pre-mixing burner and/or a porous burner. Preferably, an exhaust gas of the afterburning unit is diverted into the at least one second annular gap within which the at least one second hollow-profile coil is arranged. As a result of this, an emission of fuel gas, in particular hydrogen, may advantageously be reduced and hence the safety of the plant may advantageously be enhanced. Moreover, chemical energy of the anode exhaust gas may advantageously be converted into heat.

Advantageously, the fuel cell device has at least one separating element which from a fluid engineering point of view, preferably entirely, and/or thermally separates the at least one first heat exchanger from the at least one second heat exchanger in a mounted condition. The term “separating element” should be understood in this context to mean an element that is arranged between the at least one first heat exchanger and the at least one second heat exchanger. In particular, the at least one first heat exchanger and the at least one second heat exchanger are closed by the at least one separating element to be at least substantially gas-tight in the peripheral direction. In particular, the at least one separating element may be formed in one piece with the at least one first heat exchanger and/or the at least one second heat exchanger. As a result of this, advantageously the possibility that at least one and preferably all the fluid substance streams within the at least one first heat exchanger will mix with at least one and preferably all the fluid substance streams within the at least one second heat exchanger and/or the possibility of a mutual thermal influence between the at least one first heat exchanger and the at least one second heat exchanger can be at least largely avoided.

If the at least one first heat exchanger has at least one displacer element around which the at least one first hollow-profile coil can be at least partly guided, a fluid flow can be guided advantageously directly along the at least one first hollow-profile coil. The term “displacer element” should be understood in this context in particular to mean an at least substantially cylindrical element which is provided for the purpose of being incorporated at least substantially centrally in the at least one hollow-profile coil. An external diameter of the at least one displacer element preferably corresponds at least substantially to an internal diameter of the at least one first hollow-profile coil. Preferably, an end of the at least one displacer element that points in the opposite direction to the direction of the fluid stream takes a conical form.

Here, the fuel cell device according to the invention is not to be restricted to the application and embodiment described above. In particular, for the purpose of fulfilling a mode of operation described herein, the fuel cell device according to the invention may have a number of individual elements, constituents and units other than the number mentioned herein.

### BRIEF DESCRIPTION OF THE DRAWINGS

Further advantages will become apparent from the description of the drawings that follows. In the drawings, two exemplary embodiments of the invention are illustrated. The drawings, the description and the claims contain numerous features in combination. Those skilled in the art will, in favorable manner, also consider the features individually and group them to form useful further combinations.

In the drawings:

FIG. 1 shows a simplified sketch of the principle of a fuel cell device having an anode gas processor and a cathode gas processor,

FIG. 2 shows an isometric external view of the fuel cell device from FIG. 1, and

FIG. 3 shows an isometric sectional illustration of the fuel cell device from FIG. 2.

### DETAILED DESCRIPTION

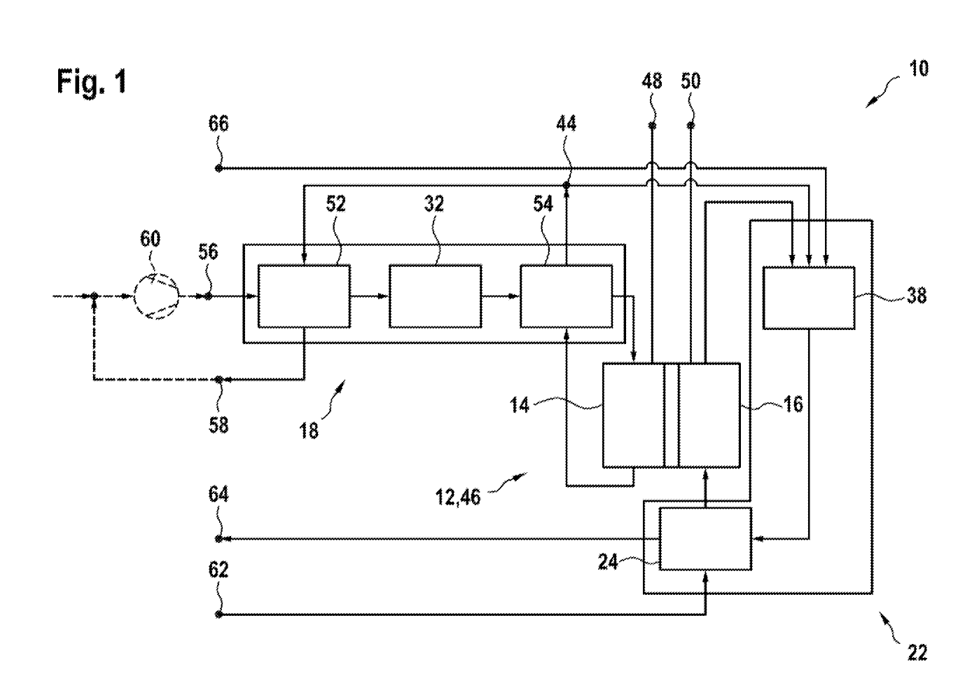

FIG. 1 shows, in a simplified sketch of the principle, a flow diagram of a fuel cell device 10 having a fuel cell unit 12. The fuel cell unit 12 is illustrated in simplified form here, as a fuel cell 46 for generating electrical and thermal energy. The electrical energy may be picked off by way of two direct current conductors 48, 50. As an alternative, however, a construction of a fuel cell unit as a fuel cell stack having a plurality of fuel cells is also conceivable. The fuel cell 46 preferably takes the form of a solid oxide fuel cell. The fuel cell 46 has an anode 14 and a cathode 16.

Moreover, the fuel cell device 10 has an anode gas processor 18 and a cathode gas processor 22. The anode gas processor 18 comprises two heat exchangers 52, 54 and a reformer unit 32 that is placed between the heat exchangers 52, 54. The cathode processor 22 comprises an afterburning unit 38 and a heat exchanger 24. The afterburning unit 38 may have for example a diffusion burner. The anode gas processor 18 and the cathode gas processor 22 may each take the form of either a structural unit or indeed of a purely functional unit.

A fresh gas is supplied to the fuel cell device 10 by way of a process connection point 56. The fresh gas is composed of fresh natural gas and a recirculate, which is guided away out of the fuel cell device 10 by way of a further process connection point 58. The natural gas and the recirculate are brought together outside the fuel cell device 10 and are compressed by means of a compressor 60.

The fresh gas is pre-heated in a first heat exchanger 52 of the anode gas processor 18, by an anode exhaust gas of the fuel cell unit 12. Then, it is guided through the reformer unit 32 into a second heat exchanger 54 of the anode gas processor 18, in which it is heated to a reaction temperature of between 650° C. and 850° C. The reformer unit 32 serves for endothermic steam reforming of the long-chain alkanes (CₓH₂₍ₓ₊₁₎, where x>1)in the natural gas:

CₓH₂₍ₓ₊₁₎+x*H₂O→x*CO+(2x+1)*H₂

The reformate that contains a fuel gas and is obtained using the reformer unit 32 is supplied to the anode 14 of the fuel cell unit 12, where it is converted in an electrochemical reaction, generating current and heat. A hot anode exhaust gas from the fuel cell unit 12 is guided to the second heat exchanger 54 of the anode gas processor 18 in order to heat the fresh gas to the reaction temperature. Since the fresh gas is not fully convertible in the anode 14 of the fuel cell unit 12, some of the anode exhaust gas is returned to the fresh natural gas as recirculate—as already described. The rest of the anode exhaust gas is supplied directly to the afterburning unit 38. Combustible constituents of the anode exhaust gas undergo afterburning in the afterburning unit 38. The heat produced in the afterburning unit 38 is used to heat surrounding air that is supplied to the fuel cell device 10 by way of a process connection point 62, for the cathode 16, and to heat for example water for a heating system (not illustrated here) downstream of a further process connection point 64.

For the electrochemical reaction in the cathode 16, the surrounding air is heated to the reaction temperature in the heat exchanger 24 of the cathode gas processor 22. After exiting the fuel cell unit 12, a cathode exhaust gas is guided directly into the afterburning unit 38. In addition to some of the anode exhaust gas, natural gas may be supplied to the afterburning unit 38 by way of a pipeline 66. This may be necessary primarily in the case of a heating procedure of the fuel cell device 10.

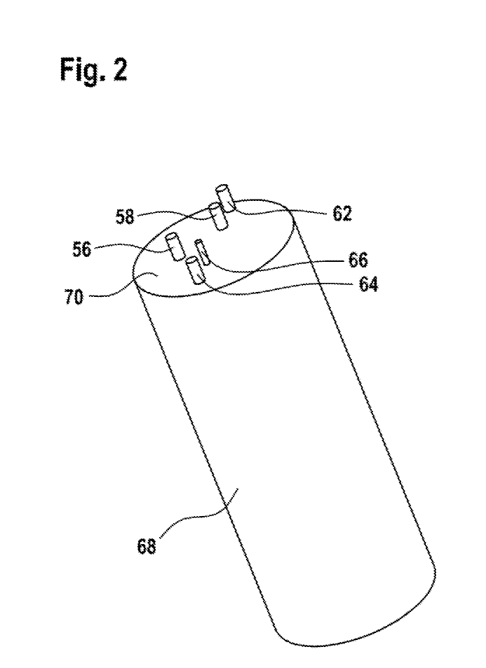

FIG. 2 shows the fuel cell device 10 in an isometric external view. The components of the fuel cell device 10 are entirely surrounded by a housing unit 68. The process connection points 56, 58, 62, 64 and the pipeline 66 are guided out of the housing unit 68 through a lid 70 of the housing unit 68.

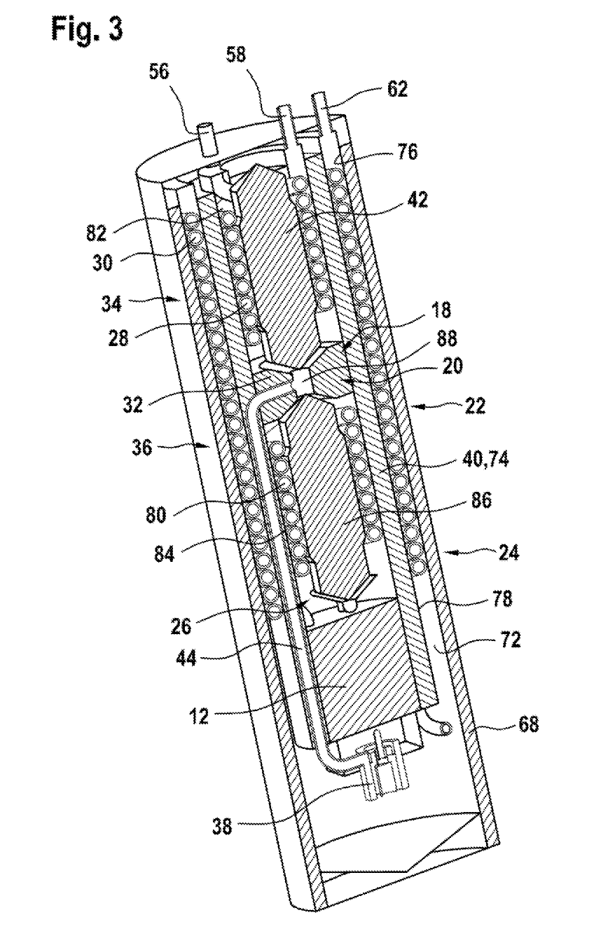

FIG. 3 shows an isometric sectional illustration of the fuel cell device 10 from FIG. 2. The heat exchanger 24 of the cathode gas processor 22 is guided around a receiving chamber 26. Arranged within the receiving chamber 26 is the heat exchanger 20 of the anode gas processor 18. Moreover, the fuel cell unit 12 and the reformer unit 32 are arranged within the receiving chamber 26. The heat exchanger 24 of the cathode gas processor 22 has a hollow-profile coil 30. The hollow-profile coil 30 of the cathode gas processor 22 is provided for the purpose of supplying surrounding air to the cathode 16 of the fuel cell unit 12. The hollow-profile coil 30 of the cathode gas processor 22 is arranged in an annular gap 72 in the heat exchanger 24 of the cathode gas processor 22. The annular gap 72 is formed by the housing unit 68 and a separating element 40 which separates the heat exchanger 20 of the anode gas processor 18, from a fluid engineering point of view and/or thermally, from the heat exchanger 24 of the cathode gas processor 22. Furthermore, the separating element 40 forms a wall 74 of the receiving chamber 26. Both the housing unit 68 and the separating element 40 have an insulation layer 76, 78 for thermal insulation. Here, the insulation layer 76 of the housing unit 68 serves for thermal insulation of the entire fuel cell device 10 from a surrounding area, while the insulation layer 78 of the separating element 40 serves in particular for thermal insulation between the heat exchanger 20 of the anode gas processor 18 and the heat exchanger 24 of the cathode gas processor 22.

The heat exchanger 20 of the anode gas processor 18 has two hollow-profile coils 28, 80 which from a fluid engineering point of view are connected in series such that the heat exchanger 20 of the anode gas processor 18 comprises two partial regions 34, 36. The partial regions 34, 36 correspond to the heat exchangers 52, 54 from FIG. 1. The reformer unit 32 is placed between the two partial regions 34, 36 from a fluid engineering point of view. As an alternative or in addition to the reformer unit 32, it is possible for example for a desulfurization unit and/or another chemical reactor unit appearing useful to those skilled in the art to be placed between the two partial regions 34, 36. A first hollow-profile coil 28 of the heat exchanger 20 of the anode gas processor 18 is provided for the purpose of supplying to the reformer unit 32 natural gas mixed in particular with some of the anode exhaust gas from the fuel cell unit 12. A second hollow-profile coil 80 of the heat exchanger 20 of the anode gas processor 18 is provided for the purpose of supplying to the anode 14 of the fuel cell unit 12 a reformate that contains hydrogen and is formed within the reformer unit 32. The hollow-profile coils 28, 80 of the heat exchanger 20 of the anode gas processor 18 are arranged within a respective annular gap 82, 84, each of which is formed by a cylindrical displacer element 42, 86 and the separating element 40. The hollow-profile coils 28, 80 of the anode gas processor 18 are each guided around one of the displacer elements 42, 86.

During operation of the fuel cell device 10, the anode exhaust gas from the fuel cell unit 12 is guided into the receiving chamber 26. The hot anode exhaust gas is guided along the hollow-profile coils 28, 80 of the heat exchanger 20 of the anode gas processor 18, directed by the displacer elements 42, 86. During this, thermal energy is transferred to the fluids that respectively flow in the hollow-profile coils 28, 80 of the heat exchanger 20 of the anode gas processor 18. The reformer unit 32 has in the center a cutout 88 through which the anode exhaust gas is guided by the displacer elements 42, 86.

An exhaust gas from the afterburning unit 38 is guided into the annular gap 72 of the heat exchanger 24 of the cathode gas processor 22. The exhaust gas is guided along the annular gap 72 at the hollow-profile coil 30 of the heat exchanger 24 of the cathode gas processor 22. During this, thermal energy is transferred to the surrounding air that is fed through the hollow-profile coil 30 of the heat exchanger 24 of the cathode gas processor 22. Some of the anode exhaust gas is fed out of the receiving chamber 26, to the afterburning unit 38, by way of a pipeline 44. During this, this quantity of the anode exhaust gas is removed at the recess 88 of the reformer unit 32.

The afterburning unit 38, the fuel cell unit 12 and the reformer unit 32 are arranged axially within the fuel cell device 10, taking account of their operating temperature in each case. Here, the component having the highest operating temperature, the afterburning unit 38, is arranged at the lowest point, while the component having the lowest operating temperature, the reformer unit 32, is arranged at the highest point. This results in a favorable temperature gradient within the fuel cell device 10. Moreover, a negative mutual thermal influence between the first heat exchanger 20 and the second heat exchanger 24 can be largely avoided.

Any gas that leaks out of the receiving chamber 26 is reliably guided away with the exhaust gas from the afterburning unit 38 by way of the heat exchanger 24 of the cathode gas processor 22, as a result of which no combustible gas can accumulate within the fuel cell device 10.

1. A fuel cell device having a fuel cell unit (12) which has at least one anode (14) and at least one cathode (16), having at least one anode gas processor (18) which has at least one first heat exchanger (20), and having at least one cathode gas processor (22) which has at least one second heat exchanger (24), characterized in that the at least one second heat exchanger (24) is at least partly guided around a receiving chamber (26) within which the at least one first heat exchanger (20) is arranged.

2. The fuel cell device according to claim 1, characterized in that the at least one first heat exchanger (20) has at least one first hollow-profile coil (28).

3. The fuel cell device according to claim 1, characterized in that the at least one second heat exchanger (24) has at least one second hollow-profile coil (30).

4. The fuel cell device according to claim 1, characterized in that the fuel cell unit (12) is arranged at least partly within the receiving chamber (26).

5. The fuel cell device according to claim 1, characterized in that the at least one anode gas processor (18) has a reformer unit (32) that is at least partly arranged within the receiving chamber (26).

6. The fuel cell device according to claim 5, characterized in that the reformer unit (32) is placed downstream, from the point of view of fluid engineering, of the at least one first heat exchanger (20).

7. The fuel cell device at least according to claim 5, characterized in that the at least one first heat exchanger (20) has at least two partial regions (34, 36) and the reformer unit (32) is placed, from the point of view of fluid engineering, between the at least two partial regions (34, 36).

8. The fuel cell device according to claim 1, characterized in that the at least one cathode gas processor (22) has an afterburning unit (38) which is configured for at least largely afterburning at least one combustible constituent of an exhaust gas.

9. The fuel cell device according to claim 1, characterized by at least one separating element (40) which from a fluid engineering point of view thermally separates the at least one first heat exchanger (20) from the at least one second heat exchanger (24) in a mounted condition.

10. The fuel cell device according to claim 2, characterized in that the at least one first heat exchanger (20) has at least one displacer element (42) around which the at least one first hollow-profile coil (28) is at least partly guided.
